(19) United States
(12) Patent Application Publication
(10) Pub. No.: US 2014/0369782 A1
(43) Pub. Date: Dec. 18, 2014

(54) LOAD-BAR ASSEMBLY HAVING ACTUATABLE LATCH ASSEMBLY

(71) Applicant: Honda Motor Co., Ltd., Tokyo (JP)

(72) Inventor: Ron Reid, Alliston (CA)

(73) Assignee: Honda Motor Co., Ltd., Tokyo (JP)

(21) Appl. No.: 14/190,161

(22) Filed: Feb. 26, 2014

(30) Foreign Application Priority Data
Jun. 13, 2013 (CA) 2819086

(51) Int. Cl. B60P 7/15

(52) U.S. Cl. CPC B60P 7/15
USPC 410/143

(57) ABSTRACT

An apparatus includes a load-bar assembly configured to latchably selectively extend between spaced-apart opposed walls once the load-bar assembly is positioned to do just so. The apparatus also includes a latch actuator configured to actuatably urge latchable operation of the load-bar assembly from a latch-extended position, in which the load-bar assembly is inadvertently jammed, to a latch-retracted position, in which the latch assembly becomes unjammed.

### TECHNICAL FIELD

Aspects are generally related to (and not limited to) a load-bar assembly, including (and not limited to) a latch assembly and a latch actuator.

### BACKGROUND

Load securing, also known as cargo securing, is the securing of cargo for transportation. The European Commission Transportation Department has estimated that up to 25% of accidents involving trucks can be attributable to inadequate cargo securing. Cargo that is improperly secured can cause severe accidents and lead to the loss of cargo, the loss of lives, the loss of vehicles, or cause environmental hazards.

There are many different ways and materials available to stabilize and secure cargo in vehicles and/or intermodal containers. Blocking and bracing is a load securement method utilizing lumber and metal bars to reduce or inhibit front to rear shifting of freight/cargo. Plastic forms are also used. Depending on the type of load and the particular vehicle, large bolts and nails may be used. These may be on the load itself or on wood blocks used to brace the load. Dunnage for securing cargo has included scrap wood to fill voids in cargo, wooden boards forming cribs, blocking and bracing, and modern mechanical, spring-loaded post-and-socket systems. Dunnage segregates cargo into the hold and prevents shifting of the cargo in response to ship or vehicle motions. Strapping is used to create a transportable unit. Types of strapping include steel, polyester, polypropylene, nylon, paper, and composites. The type of strap used depends upon the requirements, for example, strength, elasticity, ability to withstand various environments, ease of use, safety, and cost. All types of tensioned strapping, particularly steel, need to be handled carefully because of potential injury. Lashing is the securing of cargo for transportation with the goal of minimizing shifting. Items used for lashing include ropes, cables, wires, chains, strapping, and nets. These items are anchored to the container and tensioned against the cargo. Lashing may be used for devices attached to the top of each corner of a container. Whereas strapping and lashing is often used to secure odd-shaped cargo such as machinery, structures, and vehicles, dunnage bags are mostly used for homogeneous shaped cargo such as food and beverage products, electronics and appliances and roll paper. Often, strapping/lashing and dunnage bags are used in combination to secure chemical products. Dunnage bags, also known as air bags, were introduced years ago as a convenient, fast and cost-effective alternative to secure and stabilize cargo in sea-containers, closed railcars, trucks and (ocean going-) vessels. The purpose of dunnage bags is often misunderstood when they are considered as a void filler only to prevent lateral movement of cargo. When properly applied, however, dunnage bags form a 3-dimensional bulkhead of the cargo itself preventing both lateral and longitudinal movement. Heavy loads are sometimes secured to vehicles with tie down straps, heavy-duty strapping, or tensioned chains.

### SUMMARY

I, the inventor, have researched at least one problem associated with known load bars configured to secure loads in a cargo hold of a vehicle. After much study, I believe I have arrived at an understanding of at least one problem and at least one solution, which are stated below (in no particular order of importance).

Known load bars (also known as decking bars), nylon load straps, and jack bars are mechanisms configured to restrain loads in a truck during transit. An E-track system is a track system mounted to the inside walls of the back of the truck. There can be separate rows of the E-track on each of the sidewalls (on opposite facing walls). The known load bar is configured to connect to (interface with) the E-track and to secure the load from shifting and falling during transit. The load bar is configured to be lengthwise adjustable.

Known load bars are difficult to remove from the e-track for the case where the load bar is under some load pressure. In order to remove the known load bar, the operator has to use a non-ergo friendly body position and use an amount of force that exceeds ergonomic guidelines that may inadvertently result in operator injury. When the known load bars are jammed and cannot be easily removed (if at all), the operator may use pry bars to dislodge the load bar from the E-track, and this may result in operator injury along with wasted time/effort. As well, since there are no handles on the known load bars, this makes them difficult to maneuver, and the operator may have to use a high amount of pinch pressure to carry the known load bars to a storage rack.

Storage straps may not work for a trailer loaded wall to wall with cargo (a load), as during transit the load may bump against mechanisms of the straps that are interfaced with the E-track (wall track, bracket), and this situation may inadvertently cause unwanted interference or failure of the storage straps.

The jack bar (also known as a cargo bar) does not use the E-Track; the jack bar has rubber pads that are pushed outward to contact the sidewalls of the truck. The jack bar uses friction to hold itself and the load in place. The jack bar is not functional with heavier loads or loads that are susceptible to shifting.

In order to mitigate at least some of the above issues, in accordance with an aspect of my work, I (the inventor) have developed an apparatus that includes a load-bar assembly configured to latchably selectively extend between spaced-apart opposed walls once the load-bar assembly is positioned to do just so. The apparatus also includes a latch actuator configured to actuatably urge latchable operation of the load-bar assembly from a latch-extended position, in which the load-bar assembly is inadvertently jammed, to a latch-retracted position, in which the latch assembly becomes unjammed.

In order to mitigate at least some of the above issues, in accordance with an aspect of my work, I (the inventor) have developed an apparatus for a vehicle having spaced-apart opposed walls of a cargo-holding zone. The apparatus comprises a load-bar assembly configured to extend between the spaced-apart opposed walls once the load-bar assembly is positioned to do just so. The load-bar assembly has a latch assembly configured to selectively latch with a respective instance of the spaced-apart opposed walls once the latch assembly is positioned to do just so. A latch actuator is fixedly mounted to the load-bar assembly 102, and is configured to actuatably urge the latch assembly to selectively move from a latch-extended position (in which the latch assembly is inadvertently jammed with the spaced-apart opposed walls) to a latch-refracted position (in which the latch assembly becomes unjammed from the spaced-apart opposed walls so that the load-bar assembly is removable from the spaced-apart opposed walls once the latch assembly is unjammed).

In order to mitigate at least some of the above issues, in accordance with an aspect of my work, I (the inventor) have developed an apparatus for a vehicle. The vehicle has opposed wall brackets facing each other. The opposed wall brackets are mounted to spaced-apart opposed walls of a cargo-holding zone of the vehicle. The opposed wall brackets define instances of a track groove. The apparatus further comprises a load-bar assembly configured to extend between the opposed wall brackets once the load-bar assembly is positioned to do just so. The apparatus further comprises a latch assembly configured to: (A) operatively mount the load-bar assembly; (B) biasedly move toward an instance of the opposed wall brackets once the latch assembly is positioned to do just so; and (C) securely latch with the instance of the opposed wall brackets once the latch assembly is positioned to do just so. A latch actuator is configured to operatively couple with the latch assembly, and to actuatably urge the latch assembly to selectively move from a latch-extended position to a latch-retracted position.

In order to mitigate at least some of the above issues, in accordance with another aspect of my work, I (the inventor) have developed an apparatus for the vehicle. The apparatus comprises a load-bar assembly configured to extend between the opposed wall brackets. The load-bar assembly has a first end and also has a second end spaced apart from the first end. Each of the first end and the second end face a respective instance of the opposed wall brackets once the load-bar assembly is positioned to do just so. The apparatus further comprises a latch assembly configured to: (A) operatively mount at any one of the first end and the second end of the load-bar assembly; (B) biasedly move along a longitudinal axis of the load-bar assembly toward an instance of the opposed wall brackets once the latch assembly is positioned to do just so; and (C) securely latch with the instance of the opposed wall brackets once the latch assembly is positioned to do just so. The apparatus further comprises a latch actuator configured to: (A) operatively mount the load-bar assembly; and (B) actuatably urge the latch assembly to selectively move from a latch-extended position to a latch-retracted position.

In order to mitigate at least some of the above issues, in accordance with yet another aspect of my work, I (the inventor) have developed a method of operating an apparatus for a vehicle having spaced-apart opposed walls of a cargo-holding zone. The method comprises: (A) extending a load-bar assembly between the spaced-apart opposed walls once the load-bar assembly is positioned to do just so, and the load-bar assembly having a latch assembly configured to selectively latch with a respective instance of the spaced-apart opposed walls once the latch assembly is positioned to do just so; and (B) actuatably urge a latch assembly to selectively move from a latch-extended position, in which the latch assembly is inadvertently jammed with the spaced-apart opposed walls, to a latch-retracted position, in which the latch assembly becomes unjammed from the spaced-apart opposed walls so that the load-bar assembly is removable from the spaced-apart opposed walls once the latch assembly is unjammed.

In order to mitigate at least some of the above issues, in accordance with yet another aspect of my work, I (the inventor) have developed a method of operating an apparatus. The method comprises: (A) extending a load-bar assembly between the opposed wall brackets once the load-bar assembly is positioned to do just so, and a latch assembly is operatively mounted to the load-bar assembly; (B) biasedly moving the latch assembly toward an instance of the opposed wall brackets once the latch assembly is positioned to do just so; (C) securely latching the latch assembly with the instance of the opposed wall brackets once the latch assembly is positioned to do just so, and a latch actuator is operatively coupled to the latch assembly; and (D) actuatably urging the latch assembly to selectively move from a latch-extended position to a latch-retracted position.

In accordance with other aspects of my work, I (the inventor) have developed and provided other aspects as provided in the claims.

Generally speaking, the aspects of the present invention may be configured to reduce (eliminate) safety and/or ergonomic concerns associated with removing known load bars from the cargo area of a transport truck.

Other aspects and features of the non-limiting embodiments may now become apparent to those skilled in the art upon review of the following detailed description of the non-limiting embodiments with the accompanying drawings.

### BRIEF DESCRIPTION OF DRAWINGS

The non-limiting embodiments may be more fully appreciated by reference to the following detailed description of the non-limiting embodiments when taken in conjunction with the accompanying drawings, in which:

FIGS. 1A and 1B depict a side view and a top view, respectively, of a schematic example of an apparatus.

FIGS. 2A and 2B depict side views of another schematic example of the apparatus of FIGS. 1A and 1B.

FIGS. 3A, 3B and 3C depict a side view and top views, respectively, of schematic examples of the apparatus of FIGS. 1A and 1B.

FIGS. 4A and 4B depict side views of yet another schematic example of the apparatus of FIGS. 1A and 1B.

FIGS. 5A and 5B depict side views of yet another schematic example of the apparatus of FIGS. 1A and 1B.

FIGS. 6A and 6B depict side views of yet another schematic example of the apparatus of FIGS. 1A and 1B.

FIG. 7 depicts a side view of yet another schematic example of the apparatus of FIGS. 1A and 1B.

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF EXEMPLARY EMBODIMENTS

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the examples as oriented in the drawings. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments (examples), aspects and/or concepts defined in the appended claims. Hence, specific dimensions and other physical characteristics relating to the embodiments disclosed herein are not to be considered as limiting, unless the claims expressly state otherwise.

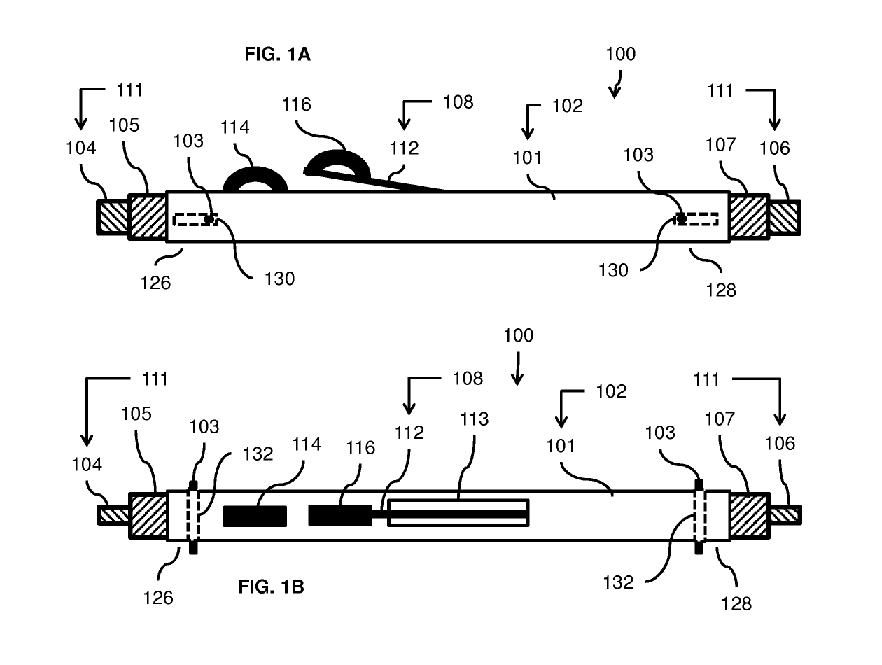

FIGS. 1A and 1B depict a side view and a top view, respectively, of a schematic example of an apparatus 100.

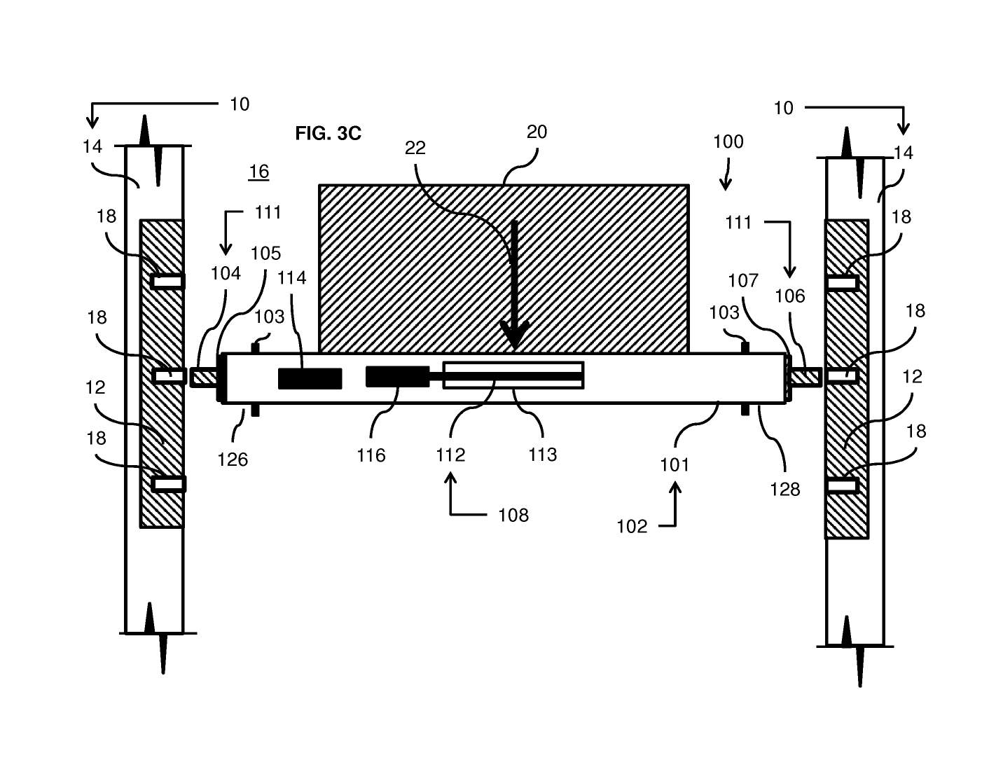

Referring now to FIGS. 3A and 3B, the apparatus 100 is, generally speaking, for a vehicle 10. An example of the a vehicle 10 is a tractor trailer (and any equivalent thereof). The vehicle 10 has opposed wall brackets 12 facing each other. The opposed wall brackets 12 are mounted to spaced-apart opposed walls 14 of a cargo-holding zone 16 of the vehicle 10. Each of the opposed wall brackets 12 defines instances of a track groove 18 positioned in a spaced-apart linear relationship (one instance positioned after the other instance) along the opposed wall brackets 12.

Referring back to FIGS. 1A and 1B, the apparatus 100 includes a load-bar assembly 102, a stop pin 103, a latch assembly 111, a first latch-support member 105, a second latch-support member 107, a latch actuator 108, a lever 112, a housing-handle assembly 114, and a lever handle 116. The load-bar assembly 102 has a housing assembly 101. The housing assembly 101 defines a housing passageway 113 configured to accommodate, at least in part, extension of the latch actuator 108 so that the latch actuator 108 may extend from inside of the load-bar assembly 102 to outside of the load-bar assembly 102. In this way, the user may have manipulative access to the exposed portion of the lever 112 that extends externally from the load-bar assembly 102. The lever 112 is operatively mounted to the load-bar assembly 102. The load-bar assembly 102 has a first end 126 and a second end 128 that is set apart from the first end 126, each of which are located at opposite ends of the load-bar assembly 102. The definition of “operatively” means in a manner to produce an effect (such as being mounted so as to operate without operative interference). The housing assembly 101 includes a central portion, and also includes (at least in part) hollow tubular members that extend from the opposite end sections of the central portion (and as well extend along the longitudinal axis that extends through the load-bar assembly 102). The hollow tubular members may have any type of cross-sectional shape (square shaped, etc.).

By way of example: (A) the first latch-support member 105 may include a movable plunger (and any equivalent thereof), (B) the second latch-support member 107 may include a movable plunger (and any equivalent thereof), and/or (C) the latch assembly 111 may include a first latch 104, and a second latch 106 spaced apart from the first latch 104. The first latch-support member 105 and the second latch-support member 107 are each configured to be slidably (movably) received in the first end 126 and the second end 128, respectively (in the hollow tubular members of the load-bar assembly 102). The definition of “slidably received” means that an object is received in a channel or groove by sliding movement or action of the object.

The housing assembly 101 defines instances of a pass-through hole 132 (depicted in FIG. 1B) positioned at the first end 126 and at the second end 128 (respectively) of the load-bar assembly 102. The pass-through hole 132 is axially aligned through the load-bar assembly 102. The pass-through hole 132 is dimensioned in such a way that the stop pin 103 may axially slide into the pass-through hole 132 (so that the stop pin 103 remains stationary relative to the load-bar assembly 102 while the stop pin 103 is received in the pass-through hole 132). The first latch-support member 105 and the second latch-support member 107 each defines an instance of an elongated slot 130 (as depicted in FIG. 1A) located proximate to a respective instance of the stop pin 103. Instances of the stop pin 103 are configured to slide into: (A) a respective instance of the pass-through hole 132 defined by the housing assembly 101, and (B) a respective instance of the elongated slot 130 defined by the first latch-support member 105, and (C) a respective instance of the elongated slot 130 defined by the second latch-support member 107. The instances of the stop pin 103 are configured to permit limited sliding movement of the first latch-support member 105 and of the second latch-support member 107 along the longitudinal axis of the load-bar assembly 102 (while the load-bar assembly 102 remains relatively stationary). In this manner, the first latch-support member 105 and the second latch-support member 107 are slidably movable between stop limits (relative to the load-bar assembly 102) along the longitudinal axis extending through the load-bar assembly 102).

For the case (not depicted) where the housing assembly 101 defines instances of the pass-through hole 132 that are linearly aligned along each instance of the first end 126 and the second end 128 of the load-bar assembly 102, the stop pin 103 is configured to allow lengthwise adjustment of the apparatus 100 (of the load-bar assembly 102). Relocation of the stop pin 103 allows the first latch-support member 105 and the second latch-support member 107 to be repositioned or relocated on the housing assembly 101 of the load-bar assembly 102. In this manner, a distance between the spaced-apart opposed walls 14 (depicted in FIG. 3B) may be accommodated depending on the particular type of vehicle 10 in which the apparatus 100 is to be used.

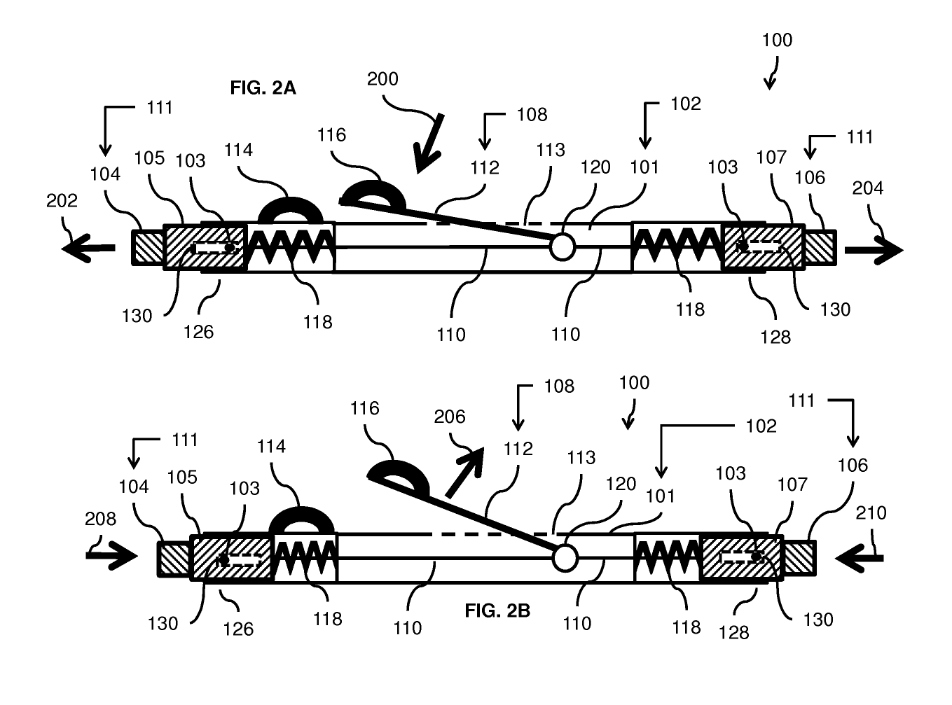

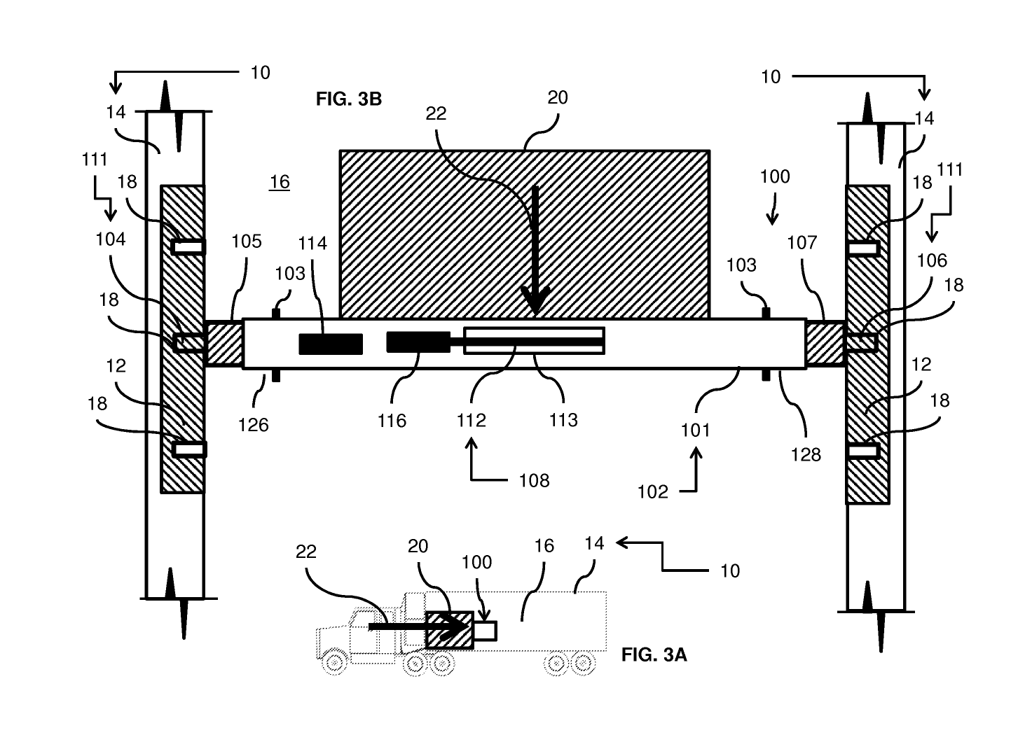

Referring to FIGS. 1A and 1B, the first latch-support member 105 and the second latch-support member 107 are slidably movable along the longitudinal axis extending through the load-bar assembly 102. The instances of the elongated slot 130 extend along the longitudinal axis of the load-bar assembly 102. The instances of the elongated slot 130 receive a respective instance of the stop pin 103 so that the first latch-support member 105 and the second latch-support member 107 are permitted to have limited linear slide movement along the longitudinal axis of the load-bar assembly 102. The instances of spring assembly 118 (not depicted in FIGS. 1A and 1B but depicted in FIGS. 2A and 2B) are mounted inside the load-bar assembly 102, and are configured to biasedly move the first latch-support member 105 and the second latch-support member 107 outwardly along the longitudinal axis of the pivot assembly 120 between physical limits or stops as a result of the stop pin 103 abutting the end sections of each instance of the elongated slot 130. The definition of “biasedly move” means that an object has a tendency or inclination or preference to move in a certain direction.

Referring to FIGS. 1A and 1B, the stop pin 103 does not move relative to the housing assembly 101 of the load-bar assembly 102, but the first latch-support member 105 and the second latch-support member 107 are movable (may travel) relative to the stop pin 103 to the extent or to the dimension of the elongated slot 130. In this manner, the first latch-support member 105 and the second latch-support member 107, generally speaking, are slidably mounted to the load-bar assembly 102 at the respective opposite ends of the load-bar assembly 102, and travel between the two limits or stops.

The first latch 104 of the latch actuator 108 extends (outwardly and away) from the first latch-support member 105 at the first end 126 along the horizontal axis that extends through the housing assembly 101. The second latch 106 of the latch actuator 108 extends (outwardly and away) from the second latch-support member 107 at the second end 128 along the horizontal axis that extends through the housing assembly 101. The first latch 104 and the second latch 106 extend in (along) opposite directions from the load-bar assembly 102 (along the longitudinal axis of the load-bar assembly 102).

By way of example, the latch actuator 108 includes: (A) the lever 112 operatively mounted to the load-bar assembly 102, and (B) the lever handle 116 that fixedly extends from the lever 112. The definition of “fixedly extends” means an object is fixedly connected to another object, and extends from said another object. The lever handle 116 is configured for user manipulation. In addition, the housing-handle assembly 114 fixedly extends axially from the housing assembly 101 of the load-bar assembly 102 at a position proximate to the first end 126, and extends from an outer portion of the load-bar assembly 102. The apparatus 100 may be configured to provide the housing-handle assembly 114 located strategically on the load-bar assembly 102 (to be balanced for carrying) to reduce the effort required (by the user) to carry the apparatus 100.

According to an option, the load-bar assembly 102 is configured to extend between the opposed wall brackets 12 (of FIG. 3B). The load-bar assembly 102 has the first end 126 and also has the second end 128 spaced apart from the first end 126. Each of the first end 126 and the second end 128 faces a respective instance of the opposed wall brackets 12 once the load-bar assembly 102 is positioned to do just so (as depicted in FIG. 3B).

According to an option, the latch assembly 111 is configured to operatively mount at any one of the first end 126 and the second end 128 of the load-bar assembly 102. The latch assembly 111 is further configured to biasedly move (is spring biased) along the longitudinal axis of the load-bar assembly 102 toward an instance of the opposed wall brackets 12 once the latch assembly 111 is positioned to do just so (as depicted in FIG. 3B). The latch assembly 111 is further configured to securely latch with instances of the opposed wall brackets 12 once the latch assembly 111 is positioned to do just so (as depicted in FIG. 3B).

According to an option, the latch actuator 108 is configured to be operatively mounted to the load-bar assembly 102. The latch actuator 108 is further configured to actuatably urge the latch assembly 111 to selectively move from a latch-extended position (as depicted in FIG. 2A) and a latch-refracted position (as depicted in FIG. 2B). The definition of “actuatably urge” means that an object is urged to operate by way of an actuator.

In accordance with another example, a method of operating the apparatus 100 is also provided. The method includes the step of extending the load-bar assembly 102 between the opposed wall brackets 12 once the load-bar assembly 102 is positioned to do just so (depicted in FIG. 3B). A latch assembly 111 is operatively mounted to the load-bar assembly 102. The method also includes the step of biasedly moving the latch assembly 111 toward an instance of the opposed wall brackets 12 once the latch assembly 111 is positioned to do just so. The method also includes the step of securely latching the latch assembly 111 with the instance of the opposed wall brackets 12 once the latch assembly 111 is positioned to do just so (as depicted in FIG. 3B). A latch actuator 108 is operatively coupled to the latch assembly 111. The method also includes the step of actuatably urging the latch assembly 111 to selectively move from a latch-extended position to a latch-refracted position.

FIGS. 2A and 2B depict side views of another schematic example of the apparatus 100 of FIGS. 1A and 1B, in which there is depicted a spring assembly 118, a pivot assembly 120, and an elongated member 110. By way of example, the elongated member 110 may include a cable element and/or a wire element (and any equivalent thereof).

FIG. 2A depicts the load-bar assembly 102 in the latch-extended position. In the latch-extended position, the latch assembly 111 is wall-bracket engagable once the latch assembly 111 is positioned to do just so in such a way that the latch assembly 111 becomes securely latched to (a selected one of) the opposed wall brackets 12 (as depicted in FIG. 3B). The first latch 104 and the second latch 106 move away from the central section of the load-bar assembly 102 along the longitudinal axis of the load-bar assembly 102.

Referring to FIG. 2A, the lever 112 is biased to move (travel) along the direction indicated by the arrow 200 (toward the load-bar assembly 102). The instances of the spring assembly 118 are configured to push (move) the first latch-support member 105 and the second latch-support member 107 along the direction indicated by the arrow 202 and the arrow 204 (respectively) away from the central portion of the load-bar assembly 102 and along opposite directions that extend along the longitudinal axis of the load-bar assembly 102. In this manner, the first latch 104 and the second latch 106 may latch with a respective instance of a track groove 18 of the opposed wall brackets 12 (as depicted in FIG. 3B).

Referring to FIG. 2B, the load-bar assembly 102 is depicted in the latch-retracted position. In the latch-retracted position, the latch assembly 111 is wall-bracket dis-engagable in such a way that the latch actuator 108 detaches the latch assembly 111 from (the selected one of) the opposed wall brackets 12 so that the load-bar assembly 102 is removable from (the selected one of) the opposed wall brackets 12 (as depicted in FIG. 3C). The first latch 104 and the second latch 106 move toward the central section of the load-bar assembly 102.

Referring to FIG. 2B, as a result of the user pulling on the lever 112, the lever 112 moves (travels) along the direction indicated by the arrow 206 (away from the load-bar assembly 102) since the user pulls with enough force to overcome the force of the spring assembly 118 in such a way that the first latch-support member 105 and the second latch-support member 107 are moved along the direction indicated by the arrow 208 and the arrow 210 (respectively) toward the central portion of the load-bar assembly 102. In this manner, the first latch 104 and the second latch 106 may be removed (de-latched) from the respective instance of the track groove 18 of the opposed wall brackets 12 (as depicted in FIG. 3C). Now the apparatus 100 may be more easily removed or relocated (in comparison to using the known load bar) so that then the load 20 may be removed from the vehicle 10 (depicted in FIG. 3C).

Referring to FIG. 2B, an instance of the spring assembly 118 is positioned between the first latch-support member 105 and the central portion of the housing assembly 101 of the load-bar assembly 102. Another instance of the spring assembly 118 is positioned between the second latch-support member 107 and the central portion of the housing assembly 101 of the load-bar assembly 102. The instances of the spring assembly 118 are configured to biasedly move (urge) the first latch-support member 105 and the second latch-support member 107 away from the central portion of the housing assembly 101. The instances of the spring assembly 118 abut the first latch-support member 105 and the second latch-support member 107, and abut the central section of the load-bar assembly 102. The instances of the spring assembly 118 extend along the longitudinal axis of the load-bar assembly 102.

The latch actuator 108 is configured to move the first latch-support member 105 and the second latch-support member 107 in such a way so as to overcome the forces of the spring assembly 118 thus retracting the first latch 104 and the second latch 106 toward the central portion of the housing assembly 101 thus overcoming the force exerted by the spring assembly 118.

According to an option, the latch assembly 111 includes the first latch 104. The elongated member 110 extends from the first latch 104 along the longitudinal length of the load-bar assembly 102. The lever 112 is operatively connected to the elongated member 110 (pivotally mounted as depicted in FIGS. 2A, 2B). The lever 112 is operatively (pivotally) mounted to the load-bar assembly 102. The lever 112 is adjustably movable in such a way that the elongated member 110 urges the first latch 104 to move from the latch-extended position to the latch-retracted position.

According to an option, the latch assembly 111 further includes the second latch 106. The elongated member 110 extends from second latch 106 along a longitudinal length of the load-bar assembly 102. The lever 112 is connected to the elongated member 110. The lever 112 is operatively mounted (pivotally) to the load-bar assembly 102. The lever 112 is adjustably movable in such a way that the elongated member 110 urges the second latch 106 to move from the latch-extended position to the latch-retracted position.

According to the following options: (A) the latch assembly 111 is configured to pivotally mount to the load-bar assembly 102, and/or (B) the lever 112 is configured to pivotally mount to the load-bar assembly 102.

According to an option, the latch actuator 108 includes the elongated member 110 and the lever 112. The elongated member 110 (such as a wire or a cable) extends from the latch assembly 111 along a longitudinal length of the load-bar assembly 102. The lever 112 is connected to the elongated member 110. The lever 112 is operatively mounted (pivotally) to the load-bar assembly 102. The lever 112 is adjustably movable in such a way that the elongated member 110 urges the latch assembly 111 to move from the latch-extended position to the latch-retracted position.

FIGS. 3A, 3B and 3C depict a side view and top views, respectively, of schematic examples of the apparatus 100 of FIGS. 1A and 1B. The apparatus 100 is for the vehicle 10. The vehicle 10 may have opposed wall brackets 12 that face each other. The opposed wall brackets 12 are mounted to the spaced-apart opposed walls 14 of the cargo-holding zone 16 of the vehicle 10. The opposed wall brackets 12 each defines instances of a track groove 18.

During transportation, a load 20 positioned in the cargo-holding zone 16 of the vehicle 10 may become displaced or may inadvertently move, and as a result, the load 20 imparts a pressure 22 directed to the apparatus 100 while the apparatus 100 is latched to the instances of the track groove 18 of the opposed wall brackets 12. As a result, the load-bar assembly 102 may become inadvertently deformably warped (but not necessarily irrevocably damaged), and thus the user may find it more difficult to remove the load-bar assembly 102 from the opposed wall brackets 12 (while the load-bar assembly 102 receives the pressure 22, the first latch 104 and the second latch 106 may become jammed). The definition of “deformably warped” means that an object may be in the state of being deformable (a measure of the extent to which something is deformable) but the object is able to recoil or spring back into its original shape after bending, stretching, or being compressed or receiving a pressure.

However, the features of the apparatus 100 may be used by the user to more conveniently remove the load-bar assembly 102 under this case. For this case, the apparatus 100 has a technical advantage in that after the vehicle 10 arrives at its destination, the user may manipulate the apparatus 100 in such a way that the apparatus 100 allows relatively easier de-latching and removal from the opposed wall brackets 12 (as depicted in FIG. 3C) in comparison to the way that the known load bars are operated and/or used.

For the case where pressure is applied to the known load bar, the user may find it difficult to remove the known load bar from the wall brackets; the known load bar may cause an ergonomic concern and/or a safety concern when they are forcibly removed from the wall brackets. When the known load bar becomes inadvertently stuck (jammed) to the wall brackets of the side walls of the vehicle 10, the user may have to use a pry bar to remove the known load bar, resulting in an increase in time to unload or remove the load from the vehicle and/or the increased possibility of unwanted injury to the user. The known load bars are relatively more difficult to remove in comparison to the effort required to remove the apparatus 100 (when the pressure 22 is applied to the apparatus 100).

For the known load bar, testing showed that the average pressure applied to the known load bar may range from 113.5 pounds to 269.5 pounds thus resulting in a required pull force (to be applied by the user) ranging from 85 pounds to 211 pounds.

In sharp contrast, the apparatus 100 was relatively easier to remove from the opposed wall brackets 12. Testing of the apparatus 100 showed that the average pressure applied to the apparatus 100 may range from 104.5 pounds to 600 pounds, resulting in a required pull force (to be applied by the user) ranging from 11.2 pounds to 21 pounds. The apparatus 100 provides a distinct advantage that improves ease of removal of the load-bar assembly 102 for the case where the load-bar assembly 102 is operatively latched to the opposed wall brackets 12 while the load-bar assembly 102 receives the pressure 22 from the load 20 (as depicted in FIGS. 3B and 3C). The apparatus 100 may be configured to provide mechanical leverage configured to retract the latch assembly 111 from the opposed wall brackets 12 (such as an E-track).

Referring to FIGS. 3B and 3C, in accordance with an option, the apparatus 100 includes a combination of the load-bar assembly 102 and the latch actuator 108. As a minimum, the apparatus 100 may be used with the vehicle 10 that has (at the very least in terms of structural components) the spaced-apart opposed walls 14 of the cargo-holding zone 16. For example, a variation of this option includes the following set-up: the vehicle 10 may or may not include the opposed wall brackets 12, if so desired, for the case where the opposed wall brackets 12 are replaced with an equivalent structure. For example, the spaced-apart opposed walls 14 are (directly or indirectly) adapted to accommodate the load-bar assembly 102. The load-bar assembly 102 is configured to extend between the spaced-apart opposed walls 14 once the load-bar assembly 102 is positioned to do just so. The load-bar assembly 102 has the latch assembly 111 configured to selectively latch with a respective instance of the spaced-apart opposed walls 14 once the latch assembly 111 is positioned to do just so. The latch actuator 108 is fixedly mounted to the load-bar assembly 102. The latch actuator 108 is configured to actuatably urge the latch assembly 111 to selectively move from the latch-extended position to the latch-retracted position. In the latch-extended position, the latch assembly 111 is inadvertently jammed with the spaced-apart opposed walls 14. In the latch-retracted position, the latch assembly 111 becomes unjammed from the spaced-apart opposed walls 14 so that the load-bar assembly 102 is removable from the spaced-apart opposed walls 14 once the latch assembly 111 is unjammed (as depicted in FIG. 3C). The latch assembly 111 becomes unjammed from the spaced-apart opposed walls 14 while the latch assembly 111 inadvertently receives the pressure 22 from the load 20. In the latch-extended position, the load 20 inadvertently imparts the pressure 22 to the load-bar assembly 102 while the latch assembly 111 is latched to the spaced-apart opposed walls 14 in such a way that the latch assembly 111 becomes inadvertently jammed.

It will be appreciated that in accordance with a broad concept, the apparatus 100 includes a variation to the load-bar assembly 102 in which the load-bar assembly 102 is configured to latchably selectively extend between the spaced-apart opposed walls 14 once the load-bar assembly 102 is positioned to do just so. The apparatus 100 also includes a variation of the latch actuator 108 in which the latch actuator 108 is configured to actuatably urge latchable operation of the load-bar assembly 102 from a latch-extended position, in which the load-bar assembly 102 is inadvertently jammed, to a latch-retracted position, in which the latch assembly 102 becomes unjammed. As well, a method is provided in which, general speaking, the method includes latchably selectively extending the load-bar assembly 102 between spaced-apart opposed walls 14 once the load-bar assembly 102 is positioned to do just so, and actuatably urging latchable operation of the load-bar assembly 102 from a latch-extended position, in which the load-bar assembly 102 is inadvertently jammed, to a latch-refracted position, in which the latch assembly 102 becomes unjammed.

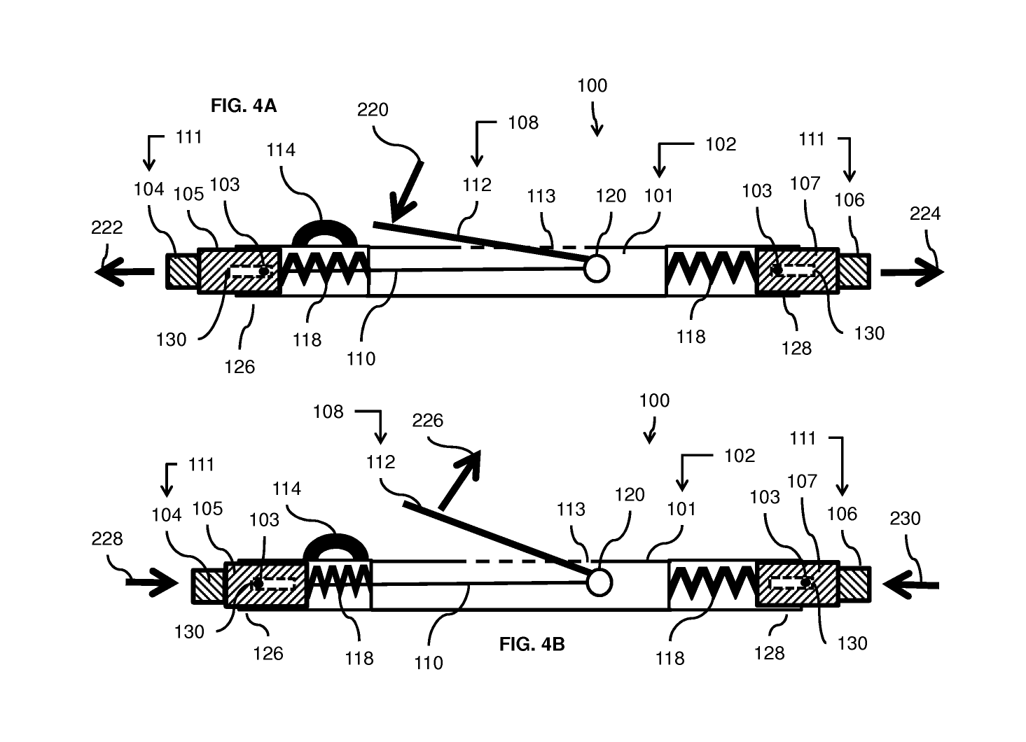

FIGS. 4A and 4B depict side views of yet another schematic example of the apparatus 100 of FIGS. 1A and 1B, in which the elongated member 110 connects the lever 112 to the first latch-support member 105. The elongated member 110 does not connect the lever 112 to the second latch-support member 107. The lever 112 is actuated so as to slidably move the first latch-support member 105 (and hence the first latch 104 as well) along the longitudinal axis of the load-bar assembly 102. Each of the first latch-support member 105 and the second latch-support member 107 are operatively coupled to respective instances of the spring assembly 118 in such a way that the first latch-support member 105 and the second latch-support member 107 are biasedly movable in response to the action of the instances of the spring assembly 118. According to this example, the elongated member 110 extends from the lever 112 to the first latch 104. The second latch 106 is not connected to the lever 112. The second latch 106 remains spring biased.

Referring to FIG. 4A, the lever 112 is biased (move or travel) along the direction indicated by the arrow 220 (toward the load-bar assembly 102). The instances of the spring assembly 118 are configured to push and move the first latch-support member 105 and the second latch-support member 107 along the direction indicated by the arrow 222 and the arrow 224 (respectively) away from the central portion of the load-bar assembly 102. In this manner, the first latch 104 and the second latch 106 may latch (couple) with the track groove 18 of the opposed wall brackets 12 (as depicted in FIG. 3B).

Referring to FIG. 4B, as a result of the user pulling on the lever 112, the lever 112 moves (travels) along the direction indicated by the arrow 226 (pivotally away from the load-bar assembly 102). The user pulls with enough force to overcome the force of the spring assembly 118 in such a way that the first latch-support member 105 and the second latch-support member 107 are moved along the direction indicated by the arrow 228 and the arrow 230 (respectively) toward the central portion of the load-bar assembly 102. In this manner, the first latch 104 and the second latch 106 may be removed from the instances of the track groove 18 of the opposed wall brackets 12 (as depicted in FIG. 3C).

Referring back to FIGS. 4A and 4B, according to an option, the latch assembly 111 includes the first latch 104 configured to operatively mount at the first end 126 of the load-bar assembly 102. The first latch 104 is also configured to securely interface with an instance of the opposed wall brackets 12 once the first latch 104 is positioned to do just so. The first latch 104 is further configured to biasedly move (such as, spring biased) along the longitudinal axis of the load-bar assembly 102 toward the latch-extended position so that the first latch 104 is wall-bracket engagable once the first latch 104 is positioned to do just so (as depicted in FIG. 3B). In this manner, the first latch 104 becomes securely latched to a selected instance of the opposed wall brackets 12. The first latch 104 is further configured to move from the latch-extended position to the latch-retracted position in response to actuation of the latch actuator 108. In the latch-retracted position, the first latch 104 is wall-bracket dis-engagable in such a way that the load-bar assembly 102 is removable from the selected one of the opposed wall brackets 12 (as depicted in FIG. 3C).

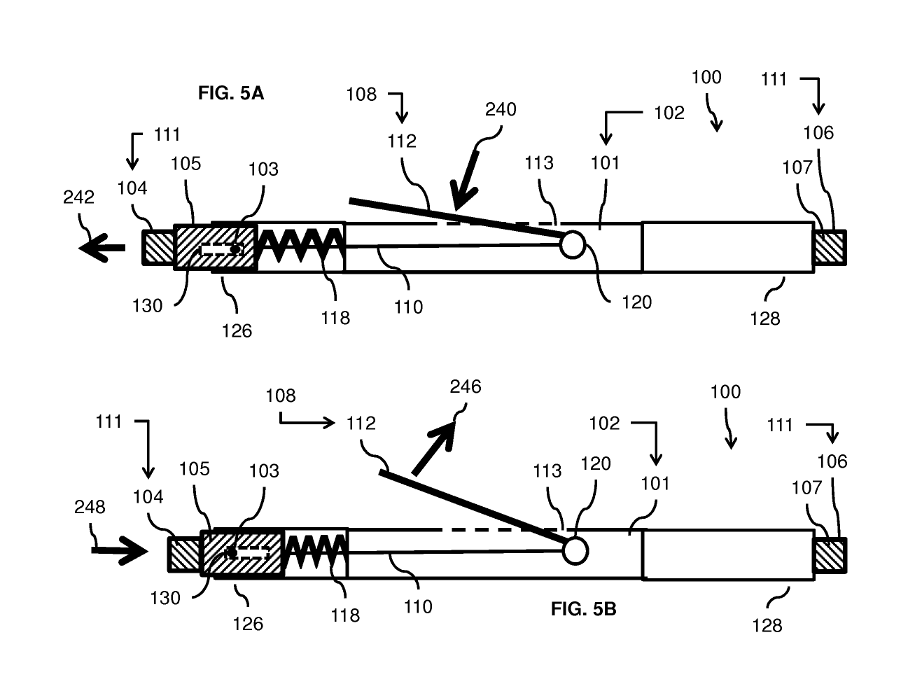

FIGS. 5A and 5B depict side views of yet another schematic example of the apparatus 100 of FIGS. 1A and 1B, in which the elongated member 110 connects the lever 112 to the first latch-support member 105. The elongated member 110 does not connect the lever 112 to the second latch-support member 107. The lever 112 is actuated so as to (slidably) move the first latch 104 along the longitudinal axis of the load-bar assembly 102. The first latch-support member 105 is operatively coupled to the spring assembly 118 in such a way that the first latch-support member 105 is biasedly movable (within limits or between stops set apart from each other). The second latch-support member 107 is fixedly attached to an end section of the load-bar assembly 102, and is not movable relative to the housing assembly 101. In this way, the second latch 106 is not spring biased but is fixedly positioned relative to the central section of the load-bar assembly 102.

Referring to FIG. 5A, the lever 112 is biased to move (travel) along the direction indicated by the arrow 240 (toward the load-bar assembly 102) since the spring assembly 118 is configured to push and move the first latch-support member 105 along the direction indicated by the arrow 242 away from the central portion of the load-bar assembly 102. In this way, the first latch 104 may be moved into an instance of the track groove 18 after the second latch 106 has been moved into position in another instance of the track groove 18 located on the opposite instance of the opposed wall brackets 12 (as depicted in FIG. 3B).

Referring to FIG. 5B, as a result of the user pulling on the lever 112, the lever 112 moves (travels) along the direction indicated by the arrow 246 (away from the load-bar assembly 102). The user pulls with enough force to overcome the force of the spring assembly 118 in such a way that the first latch-support member 105 is moved along the direction indicated by the arrow 248 toward the central portion of the load-bar assembly 102. In this manner, the first latch 104 is retracted from an instance of the track groove 18 (depicted in FIG. 3C) so that the load-bar assembly 102 may then be removed; in response, the second latch 106 becomes removed from the track groove 18 (as the load-bar assembly 102 is removed; depicted at least in part in FIG. 3C).

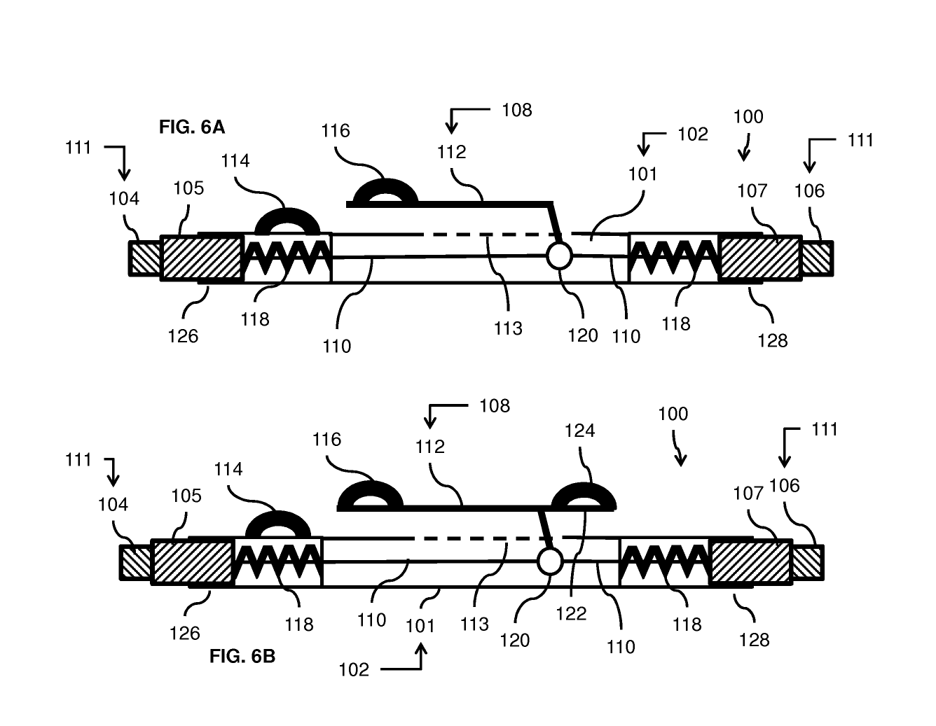

FIGS. 6A and 6B depict side views of yet another schematic example of the apparatus 100 of FIGS. 1A and 1B, in which the elongated member 110 connects the lever 112 to the first latch-support member 105, and connects the lever 112 to the second latch-support member 107. The lever 112 is actuated so as to (slidably) move the first latch 104 and the second latch 106 along the longitudinal axis of the load-bar assembly 102. The first latch-support member 105 is operatively coupled to an instance of the spring assembly 118 and the second latch-support member 107 is operatively coupled to an instance of the spring assembly 118 in such a way that the first latch-support member 105 and the second latch-support member 107 are biasedly (slide) movable.

FIG. 6A depicts two instances of a handle. FIG. 6B depicts three instances of a handle (two instances of the handle each positioned at opposite ends of the lever 112). In accordance with an option, the lever 112 includes a bent or angled section (arm) so that in the latch extended position, the lever 112 is aligned parallel to the longitudinal axis that extends through the load-bar assembly 102. FIG. 6B depicts an auxiliary extension 122 and an auxiliary handle assembly 124 (if so desired as an option). In accordance with several options: (A) the lever 112 includes a lever handle 116 extending from the lever 112, and/or (B) the lever 112 further includes an auxiliary handle assembly 124 attached to and extending from an outer portion of the load-bar assembly 102, and the auxiliary handle assembly 124 is spaced apart from the lever handle 116.

The latch assembly 111 includes the first latch 104 and also includes the second latch 106. The second latch 106 is configured to: (A) operatively mount to the second end 128 of the load-bar assembly 102; and (B) securely interface with an instance of the opposed wall brackets 12 once the second latch 106 is positioned to do just so. The second latch 106 is configured to biasedly move (such as, spring biased) along the longitudinal axis of the load-bar assembly 102 toward the latch-extended position; in this manner, the second latch 106 is wall-bracket engagable once the second latch 106 is positioned to do just so. In this manner, the second latch 106 becomes securely latched to a selected one of the opposed wall brackets 12. The second latch 106 is configured to move from the latch-extended position to the latch-retracted position in response to actuation of the latch actuator 108. In the latch-refracted position, the second latch 106 is wall-bracket dis-engagable in such a way that the load-bar assembly 102 is removable from the selected one of the opposed wall brackets 12 (as depicted in FIG. 3C).

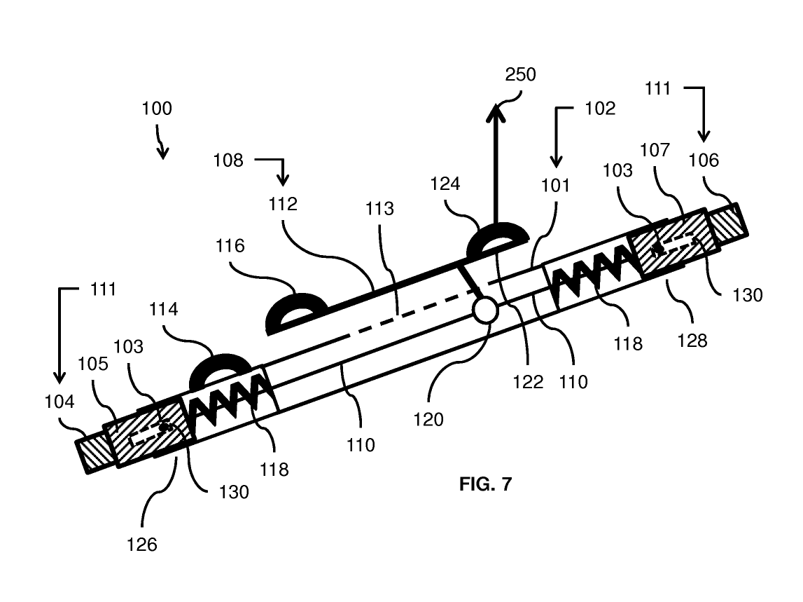

FIG. 7 depicts a side view of yet another schematic example of the apparatus 100 of FIGS. 1A and 1B. The arrow 250 indicates the direction in which the user pulls on the load-bar assembly 102 so that the load-bar assembly 102 is balanced in an angled alignment, and thus the apparatus 100 may be more easily stored in a vertical position in a vertically-aligned rack storage system (not depicted).

The apparatus 100 provides the load-bar assembly 102 configured to interface with a wall track, such as an E-track or any equivalent thereof. The apparatus 100 may include the latch assembly 111 (such as, the lever 112) configured to provide a mechanical advantage for the user of the apparatus 100 in such a way so as to reduce user (operator) effort required to remove the apparatus 100 from the wall track (E-track). The apparatus 100 may be configured to allow the user to maintain an ergonomically friendly body position. The lever 112 may be configured (as an option) to be pulled along a straight up and a smooth motion. For example, with a 16:1 mechanical advantage provided by the lever 112, the need to use pry bars may be reduced (if not entirely eliminated) thereby reducing the potential of inadvertent and unwanted injury to the user. The apparatus 100 helps reduce the amount of effort the user requires for removing jammed known load bars and/or not having to find and use pry bars to remove the jammed known load bars and therefore may result in efficiency (faster loading and unloading of cargo from the vehicle). If so desired (as an option), a carry handle may be used and make the apparatus 100 easier to maneuver with a reduced amount of pinch force to be applied by the user. The lever 112 may be mounted to a top section of the apparatus 100. The lever 112 may be configured to interact with a gear system that pulls the elongated member 110 that runs inside the apparatus 100 from the gear system to the latch assembly 111 positioned on at least one end or at each end section (portion) of the apparatus 100. The latch assembly 111 may be configured to release the apparatus 100 from the wall track (E-track). The latch assembly 111 may be strategically located on the apparatus 100 to cooperate in conjunction with the handle attached to the apparatus 100 in such a way that the operator may manipulate the load-bar assembly 102 in a balanced and ergo-friendly carrying position.

It may be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a load-bar assembly being configured to latchably selectively extend between spaced-apart opposed walls once the load-bar assembly is positioned to do just so; and
a latch actuator being configured to actuatably urge latchable operation of the load-bar assembly from a latch-extended position, in which the load-bar assembly is inadvertently jammed, to a latch-retracted position, in which the latch assembly becomes unjammed.

2. An apparatus for a vehicle having spaced-apart opposed walls of a cargo-holding zone, the apparatus comprising:
a load-bar assembly being configured to extend between the spaced-apart opposed walls once the load-bar assembly is positioned to do just so, and the load-bar assembly having a latch assembly being configured to selectively latch with a respective instance of the spaced-apart opposed walls once the latch assembly is positioned to do just so; and
a latch actuator being fixedly mounted to the load-bar assembly, and being configured to actuatably urge the latch assembly to selectively move from a latch-extended position, in which the latch assembly is inadvertently jammed with the spaced-apart opposed walls, to a latch-retracted position, in which the latch assembly becomes unjammed from the spaced-apart opposed walls so that the load-bar assembly is removable from the spaced-apart opposed walls once the latch assembly is unjammed.

3. An apparatus for a vehicle having opposed wall brackets facing each other and being mounted to spaced-apart opposed walls of a cargo-holding zone of the vehicle, and the opposed wall brackets defining instances of a track groove, the apparatus comprising:
a load-bar assembly being configured to extend between the opposed wall brackets, the load-bar assembly having a first end and also having a second end being spaced apart from the first end, and each of the first end and the second end facing a respective instance of the opposed wall brackets once the load-bar assembly is positioned to do just so;
a latch assembly being configured to: (A) operatively mount at any one of the first end and the second end of the load-bar assembly; (B) biasedly move along a longitudinal axis of the load-bar assembly toward an instance of the opposed wall brackets once the latch assembly is positioned to do just so; and (C) securely latch with the instance of the opposed wall brackets once the latch assembly is positioned to do just so; and
a latch actuator configured to: (A) operatively mount the load-bar assembly; and (B) actuatably urge the latch assembly to selectively move from a latch-extended position to a latch-retracted position.

4. The apparatus of claim 3, wherein:
in the latch-extended position, the latch assembly is wall-bracket engagable once the latch assembly is positioned to do just so in such a way that the latch assembly becomes securely latched to a selected one of the opposed wall brackets.

5. The apparatus of claim 4, wherein:
in the latch-retracted position, the latch assembly is wall-bracket dis-engagable in such a way that the latch actuator detaches the latch assembly from the selected one of the opposed wall brackets so that the load-bar assembly is removable from the selected one of the opposed wall brackets.

6. The apparatus of claim 3, wherein:
the latch assembly includes:
a first latch being configured to: (A) operatively mount at the first end of the load-bar assembly; and (B) securely interface with the instance of the opposed wall brackets once the first latch is positioned to do just so.

7. The apparatus of claim 6, wherein:
the first latch is further configured to:
biasedly move along the longitudinal axis of the load-bar assembly toward the latch-extended position so that the first latch is wall-bracket engagable once the first latch is positioned to do just so in such a way that the first latch becomes securely latched to a selected one of the opposed wall brackets.

8. The apparatus of claim 7, wherein:
the first latch is further configured to:
move from the latch-extended position to the latch-retracted position in response to actuation of the latch actuator so that in the latch-retracted position, the first latch is wall-bracket dis-engagable in such a way that the load-bar assembly is removable from the selected one of the opposed wall brackets.

9. The apparatus of claim 6, wherein:
the latch assembly further includes:
a second latch being configured to: (A) operatively mount to the second end of the load-bar assembly; and (B) securely interface with the instance of the opposed wall brackets once the second latch is positioned to do just so.

10. The apparatus of claim 7, wherein:
the second latch is configured to:
biasedly move along the longitudinal axis of the load-bar assembly toward the latch-extended position so that the second latch is wall-bracket engagable once the second latch is positioned to do just so in such a way that the second latch becomes securely latched to a selected one of the opposed wall brackets.

11. The apparatus of claim 10, wherein:
the second latch is configured to:
move from the latch-extended position to the latch-retracted position in response to actuation of the latch actuator, so that in the latch-retracted position, the second latch is wall-bracket dis-engagable in such a way that the load-bar assembly is removable from the selected one of the opposed wall brackets.

12. The apparatus of claim 3, wherein:
the latch actuator includes:
an elongated member extending from the latch assembly along a longitudinal length of the load-bar assembly; and
a lever being connected to the elongated member, being operatively mounted to the load-bar assembly, and being adjustably movable in such a way that the elongated member urges the latch assembly to move from the latch-extended position to the latch-retracted position.

13. The apparatus of claim 3, wherein:
the latch actuator includes a lever handle extending from the latch actuator.

14. The apparatus of claim 12, wherein:
the latch assembly includes a first latch;
the elongated member extends from the first latch along the longitudinal length of the load-bar assembly; and
the lever is connected to the elongated member, the lever is operatively mounted to the load-bar assembly, and is adjustably movable in such a way that the elongated member urges the first latch to move from the latch-extended position to the latch-retracted position.

15. The apparatus of claim 14, wherein:
the latch assembly further includes a second latch;
the elongated member extends from the second latch along the longitudinal length of the load-bar assembly; and
the lever is connected to the elongated member, the lever is operatively mounted to the load-bar assembly, and is adjustably movable in such a way that the elongated member urges the second latch to move from the latch-extended position to the latch-retracted position.

16. The apparatus of claim 3, wherein:
the latch assembly is configured to pivotally mount to the load-bar assembly.

17. The apparatus of claim 12, wherein:
the lever is configured to pivotally mount to the load-bar assembly.

18. The apparatus of claim 12, wherein:
the lever includes a lever handle extending from the lever.

19. The apparatus of claim 18, wherein:
the lever further includes an auxiliary handle assembly attached to and extending from an outer portion of the load-bar assembly, the auxiliary handle assembly being spaced apart from the lever handle.

20. The apparatus of claim 3, wherein:
the latch actuator is configured to actuatably urge the latch assembly to selectively move from the latch-extended position, in which the latch assembly is inadvertently jammed with the spaced-apart opposed walls, to the latch-retracted position, in which the latch assembly becomes unjammed from the spaced-apart opposed walls so that the load-bar assembly is removable from the spaced-apart opposed walls once the latch assembly is unjammed.
